(19) United States
(12) Patent Application Publication
(10) Pub. No.: US 2016/0093001 A1
(43) Pub. Date: Mar. 31, 2016

(54) INTERFACE FOR COMMUNICATION BETWEEN AN ITEM OF EQUIPMENT AND A FLUID METERING SYSTEM

(71) Applicant: ELECTRICITE DE FRANCE, Paris (FR)

(72) Inventor: Yves Dherbecourt, Bourg La Reine (FR)

(21) Appl. No.: 14/787,787

(22) PCT Filed: Apr. 29, 2014
(86) PCT No.: PCT/FR2014/051027

§ 371 Date: Oct. 29, 2015

(30) Foreign Application Priority Data
Apr. 30, 2013 (FR) 13 53991

(51) Int. Cl. G06Q 50/06; H04W 4/00; H04B 3/54

(52) U.S. Cl. CPC G06Q 50/06; H04B 3/54; H04W 4/005

(57) ABSTRACT

A device for communication between at least one item of equipment of an installation and a fluid meter for metering a quantity of fluid consumed by said at least one item of equipment, said meter and said at least one item of equipment being linked to the fluid network of the installation, said device comprising: a first communication interface configured so as to communicate by power-line carrier with the meter and possibly with a concentrator and, through the intermediary thereof, with a metering information system, and a second communication interface configured so as to communicate wirelessly with said at least one item of equipment, each of the first and second interfaces being configured for a bidirectional communication.

### TECHNICAL FIELD

The object of the present invention concerns the field of controlling the consumption of fluid by one or more devices in an installation such as an industrial or a household installation.

One aim of the invention is to facilitate the dissemination of information between a fluid meter (also known as a utility meter) and the equipment of an installation, while at the same time enabling auxiliary meter reading and local load-balancing.

Another aim of the invention is to provide consumers with access to intelligent information services, for example by displaying information and advice concerning fluid consumption in order to manage such consumption.

Fluid in the meaning of the invention is to be understood in the following description as any energy source, such as such as electricity, water, or gas or fuel oil, which can be consumed by equipment for its operation.

### STATE OF THE ART

Management of fluid consumption poses a daily and growing challenge, both for individuals and for manufacturers or communities: the reasons for managing this consumption are both economic (high financial costs) and ecological (pollution, natural resources).

Fluid meters are generally basic, and only provide a conventional usage reading for all equipment of an installation. At best, the most efficient meters provide a multi-fluid usage reading.

There are also meters, called smart meters, which are configured to communicate with equipment located downstream of the meter; meaning in the downlink direction, from the meter toward the installation equipment.

Most often, these smart meters incorporate a fixed or removable radio communication module.

This type of smart meter has several drawbacks, however.

Such meters have an often limited range of radio communication, such that the transmission of information quickly becomes impossible between meter and equipment. This is especially true when the meter is physically remote from the installation.

The Applicant further submits that each meter generally includes only one radio communication module. The meter therefore communicates with a single predefined communication protocol, which sometimes can be very difficult to modify once installed.

When a radio communication module is fixed (integrated into the meter), it is simply not possible to change the communication protocol used.

When the radio communication module is removable and the equipment items of the installation are each configured to use different protocols, it is necessary in this case to select one protocol over the others.

Regardless of the configuration of the radio communication module (removable/fixed), current smart meters only allow communicating with equipment supporting a single communication protocol.

In addition, the use of a radio communication module using a wireless communication protocol such as “WiFi®” requires a lot of electrical energy; however, the supply of power to the radio module from the meter is generally low, which prevents the use of such protocols.

Installation of these additional communication modules is often very difficult, if not impossible, for a private party, especially when the existing meter cannot be directly accessed (for example, when the meter is in a cabinet or utilities room).

Finally, the Applicant observes that smart meters do not allow data to be sent from equipment to the meter for the purposes of providing relevant information services.

The company ENEL, particularly in document WO 2012/045357, proposes a “SmartInfo” system that communicates unidirectionally, downstream of the meter.

The solution proposed by ENEL in no way provides for the possibility of collecting information on each of the equipment items of an installation, or for transmitting this information upstream of the meter (for example to the concentrator).

Document US 2008/117077 proposes a communication interface for communicating the set of metering data collected by the meter to a concentrator which acts as a data center.

Indeed, as illustrated in FIG. 4 of document US 2008/117077, the meters 405 collect and transmit metering data via wireless communication means to the AMR (“Automated Meter Reading”) interface 401.

The interface 401 then communicates these data to the concentrator 416, by power-line carrier (PLC) technology.

This solution, while interesting, does not allow providing households and the end consumer with all the metering data collected by the meter.

Thus, document US 2008/117077 only seeks to improve the sending of metering data to a concentrator by providing a “bidirectional” bridge comprising wireless communication means for communicating with all the meters and PLC communication means for communicating with the concentrator.

The prior art does not offer intelligent solutions for delivering, directly to consumers, information services concerning their fluid consumption. In addition, although some meters allow reading gas consumption data in addition to electricity consumption data, none of the smart meters of the prior art allow transmitting other data originating from the installation.

### OBJECT AND SUMMARY OF THE PRESENT INVENTION

The object of the present invention is to improve the situation described above.

For this purpose, the object of the present invention provides a device for communication between one or more equipment items of an installation and a fluid meter.

According to the invention, such a fluid meter is configured to measure an amount of fluid consumed by the set of equipment items of the installation.

Advantageously, the equipment items of the installation and the fluid meter are connected to the fluid distribution network of the installation.

It will be understood here that, in the specific case of an electricity meter, the equipment of the installation and the electricity meter are connected to the power grid for the installation.

To facilitate communication between the different entities of the infrastructure described above, the device according to the invention preferably comprises:
a first communication interface that is configured for communicating by power-line carrier, or PLC, with the meter, and
a second communication interface that is configured for communicating wirelessly with each equipment item.

Advantageously, each of the first and second interfaces is configured for bidirectional communication.

Such a device therefore interfaces between the meter and the equipment items of an installation (for example an industrial or household installation) and provides bidirectional communication between the meter and the equipment items of the installation, even if the meter is remote from the equipment items (for example in a post outside a dwelling), and could not in this case communicate directly with the equipment items.

This is different from document US 2008/117077, which provides a bridge that interfaces between the fluid meter and the concentrator and which allows the meter to communicate directly upstream of the meter (meaning the concentrator and the metering information system) in order to optimize the collection of metering data.

In this novel architecture proposed in the context of the invention, the PLC communication capabilities of the meter, provided for communicating upstream of the meter, are used for bidirectional communication downstream of the meter.

Having a bidirectional communication between the equipment items and the meter enables communication both in the downlink direction, toward the equipment items, and in the uplink direction, toward the meter.

The “downlink” data originating from the meter concern the metering data collected by the meter as well as the customer data, or contractual data, such as for example data relating to the contract or to the occurrence of a non-fixed point (rate data, etc.).

The “downlink” data originating from the meter also facilitate the development of improved services for the end consumer.

For example, with the invention it is now possible to provide all equipment items of an installation with functional dependencies linked to off-peak hours, a service currently only possible for hot water tanks.

None of the solutions proposed in the prior art offer such services directly to the end consumer.

Using the various services offered, the consumer can make consumption decisions based on the communicated data, particularly with a view to reducing consumption.

The device according to the invention also ensures bidirectional communication with all equipment items of the installation for the long term, regardless of the radio communication protocol used by these equipment items.

This flexibility ensures that once the metering system is in place, it can continue to “talk” with the various equipment items of the installation; the communication technology deployed in such equipment items generally has very short replacement cycles and is therefore likely to change over time. It is currently difficult to ensure interoperability of existing systems when they are regularly updated.

Optionally, the first communication interface is also configured to communicate bidirectionally with a concentrator.

This first communication interface is thus used to communicate directly with the concentrator, and possibly to communicate indirectly through the concentrator with a metering information system.

This communication of information to the concentrator and possibly to the metering information system allows providing the end consumer, in a single, easily accessible user interface (for example a web interface), with all the data originating from both the meter and the equipment items.

This allows enriching the associated services by sending information originating from the equipment items to the concentrator and then to the metering information system, for example information concerning the consumption of each equipment item, allowing for example later generation of appropriate services, such as web services, according to consumption or peak consumption of the entire installation or of a specific equipment item.

Advantageously, the first communication interface is configured to use a narrowband power-line communications protocol such as G3-PLC.

The use of such a protocol standardizes communications between the various entities that are involved, without structurally modifying the existing arrangement.

Advantageously, the second communication interface comprises at least one wireless communication module arranged to communicate with one or more equipment items according to one or more predefined wireless communication protocols.

Alternatively, the wireless communication module may comprise a removable radio dongle such as a USB dongle adapted to connect to the device electrically.

Thus, in an advantageous embodiment, the device according to the invention consists for example of a G3-PLC connector composed of:
a main part which constitutes the base of the device and which is configured to communicate using G3-PLC with the meter and optionally with the concentrator, and
one or more radio dongles which are each plugged into a USB connector of the base.

In this embodiment, the device of the invention is very simple to use and to install.

The device of the invention preferably has embedded intelligence.

For this purpose, in one variant it comprises a processing module which is configured to transmit one or more control data items to the equipment item or items via the second communication interface; each control data item contains one or more information items for controlling fluid consumption by the equipment item or items.

In a variant, the one or more control data items are generated by the concentrator or by the metering information system. These control data items are then sent from the concentrator:
to the meter which then routes them to the device, along with other metering data useful for control,
or directly to the device, particularly in the case of complex control data not managed by the meter such as the charging schedule of a terminal for an electric vehicle.

In both cases, the processing module is used as a relay.

In another variant, the processing module is configured to generate the control data item or items.

In this embodiment, the processing module is configured such that the control data item or items are generated based on at least one event data item transmitted by the meter (or concentrator) via the first communication interface; said at least one event data item contains information relating to an event (for example a rate change or a delete request which for example are determined by the meter, the concentrator, and/or the metering information system).

In another variant which may possibly be combined with the previous variant, the processing module is configured such that the one or more control data items are generated based on at least one equipment data item containing information relating to one or more equipment items (for example an amount of fluid consumed or a fluid consumption characteristic).

Advantageously, said at least one equipment data item is transmitted directly by the one or more equipment items via the second communication interface.

As mentioned above, the first communication interface can be configured to communicate directly with the concentrator, it may possibly also communicate indirectly via the concentrator with a metering information system.

Advantageously, said first communication interface is configured to transmit to the concentrator and possibly to the metering information system at least one status data item originating from said at least one equipment item and received by the device via the second communication interface; this status data item contains at least one information item concerning the status of said at least one equipment item.

Preferably, the status data item is a data item generated by said at least one equipment item upon receipt by said at least one equipment item of said at least one control data item.

Thus, regardless of the control variant, the function of sending information from the equipment items to the concentrator and to the metering information system enables the return of feedback or status information from the equipment items that have received these control data.

Such feedback allows, for example, confirming that control actions have been completed.

For example, following an “delete” command, information about the behavior of the equipment item or its energy consumption for the duration of the deletion period and its properly completed return to normal state at the end of the deletion period will be sent to the concentrator and then to the metering information system; it is thus possible to detect any abnormality in the implementation of this control action and to launch corrective actions or generate an alert.

Status data can also be sent back periodically with no control actions required (for example period feedback indicating consumption by a SmartPlug to which equipment is connected). In a variant, the device according to the invention may comprise a display means possibly communicating by radio link and configured to display information relating to at least one equipment item.

Alternatively, information may be displayed via a communication terminal such as a digital tablet, smartphone, or computer equipped with communication means (Internet).

The information displayed may for example concern fluid consumption, consumption recommendations, information on the rate period, on the duration of a deletion period, etc.

This information may arrive:
via the first interface, from the metering system, meaning from the meter, concentrator, or metering information system, and/or
via the second interface, from the equipment items of the installation.

Thus, by its various structural and functional aspects, the invention overcomes the stated disadvantages of the prior art by providing a communicating device that is easy to connect, which fits into the existing infrastructure, and which offers numerous information services to the end consumer and/or services for remote control of the equipment items of an installation.

### BRIEF DESCRIPTION OF THE ACCOMPANYING FIGURES

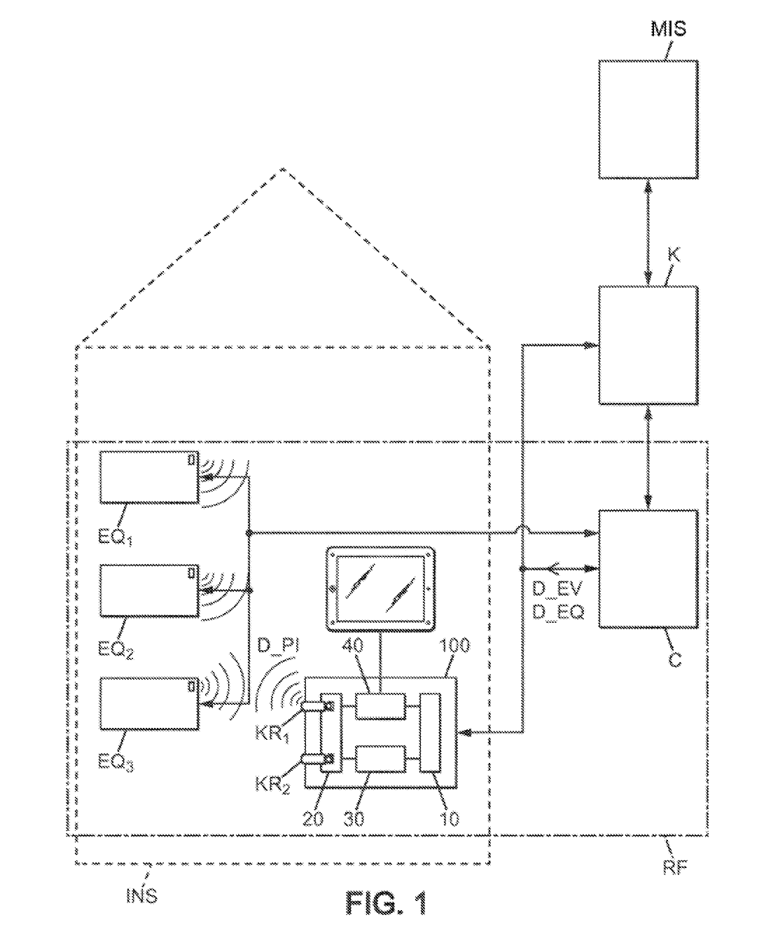

Other features and advantages of the invention will be apparent from the following description, with reference to the sole FIG. 1 which illustrates an embodiment having no limiting character and in which is schematically represented a communication device according to an exemplary embodiment of the invention.

### DETAILED DESCRIPTION OF AN EMBODIMENT OF THE INVENTION

A communication device according to an advantageous embodiment will now be described below, with reference to the sole FIG. 1.

One aim of the invention is to enable the deployment of new services downstream of the meter and intended for the end consumer, without structurally changing the existing metering infrastructure.

Providing a solution to the interoperability issues of an installation such as a home is one of the other aims of the invention.

For this purpose, in the example described and as illustrated in FIG. 1, the communication device 100 according to the invention enables communication between equipment items EQ1, EQ2, EQ3 and a residential or household installation INS, a concentrator K, a metering information system MIS, and a fluid meter C such as an electricity meter configured to measure the amount of electricity used by the set of equipment items of the installation INS, in particular including EQ1, EQ2, and EQ3.

In the example described here and as illustrated in FIG. 1, the equipment items EQ1, EQ2, EQ3 and the fluid meter C are connected to the electricity distribution network RF of the installation INS (represented in FIG. 1 by the dot/dash line).

The example described herein relates more particularly to a household installation; of course, as mentioned above, this is a purely illustrative and in no way limiting example, and those skilled in the art will understand here that it includes all types of installation.

Similarly, the example described here concerns an electricity meter C; those skilled in the art will understand that it concerns all types of fluid meter as defined in the preamble of the description.

As an illustration, the equipment item EQ1, EQ2, and EQ3 may be for example: a water heater, an electric heater, a washing machine, a heat pump, a refrigerator, a washing machine, a presence sensor, etc.

Of course, other equipment may be concerned, for example such as an auxiliary gas meter or an auxiliary water meter. In this case, such equipment can be treated as equipment items of the installation in the sense of the invention, provided that such equipment (auxiliary gas meter, auxiliary water meter, etc.) is able to communicate, for example by radio.

In this example, the meter C, the concentrator K, which together form what is referred to as the NAN (“Neighborhood Area Network”), are able to communicate according to a G3-PLC communication protocol.

The concentrator K and the metering information system MIS communicate over a WAN (“Wide Area Network”) link, which may consist of any type of link for long distance communication, including the Internet.

One aim of the invention is to allow intelligent communication and the exchange of information between the various entities above.

Thus, the communication device 100 according to the invention is an information bridge placed between the equipment items and the fluid meter, in the example described here, this bridge has first 10 and second 20 communication interfaces which are adapted for two-way communication with these different entities.

In the example described herein and as illustrated in FIG. 1, the first interface 10 is configured to communicate with the meter C via powerline carrier according to protocol G3-PLC.

Other narrowband protocols are conceivable, such as the PRIME protocol for example.

It is also possible to consider using wider bandwidth protocols such as “HomePlug GreenPHY™” for example.

In the current example, the first interface 10 is further configured for power-line communication with the concentrator K. The first interface 10 is also configured for indirect communication with the metering information system MIS via the concentrator K and the WAN link.

In the example described herein and as illustrated in FIG. 1, the second communication interface 20 is configured for wireless communication with each equipment item EQ1, EQ2, and EQ3.

For this purpose, in the example described, this interface 20 comprises two wireless communication modules, each consisting of a radio dongle KR1 and KR2 each arranged to communicate with at least one of the equipment items EQ1, EQ2, EQ3.

Of course, it is understood that here the interface 20 may comprise more than two modules KR1 and KR2.

These modules KR1 and KR2 are configured to communicate with the equipment items EQ1, EQ2, EQ3 using one or more predefined wireless technologies, such as “W-Mbus”, “WiFi®”, “BlueTooth®”, “IEEE802.15.4” (also called “Zigbee”), “KNX”, etc.

These modules KR1 and KR2, which plug into the different USB connectors of the main body of the device 100, allow elements of the “HAN” (“Home Area Network”) to communicate among themselves and to transmit information to or receive information from the “NAN”, meaning the meter C and/or the concentrator K and therefore, via the concentrator K, the metering information system MIS.

The device 100 according to the invention thus constitutes a true communication interface between “HAN” and “NAN” and enables bidirectional communication of information between these two entities, which increases the synergy between “HAN” and “NAN”.

As indicated above, in the example described here each of the first 10 and second 20 interfaces is configured for bidirectional communication, allowing transfer of data in both the downlink and uplink directions, which is not provided for in the various solutions proposed in the prior art to date.

The device 100 is integrated into the existing metering system, and maintains the security of PLC exchanges with the meter C and concentrator K: the COSEM/DLMS application protocol is preferably used for this purpose.

To provide intelligent services, which is an aim of the invention, the communication device 100 comprises a processing module 30 which is configured to relay or generate at least one control data item D_PI.

As illustrated in FIG. 1, this control data item D_PI, which is sent via the second communication interface 20 to one or more equipment items EQ1, EQ2, EQ3, contains one or more information items (for example command information) for controlling fluid consumption.

The fact that the communication is bidirectional thus allows:
in a downlink direction, the transmission of one or more commands, for example a delete command and/or a command to reduce consumption during peak hours, directly to the equipment items EQ1, EQ2, EQ3 via one or more control data items D_PI, and
in an uplink direction, the transmission to the meter C or concentrator K of specific information (for example such as in document FR 2,808,149 with the DAL application) and/or information other than the electrical power usage reading (for example a reading of the gas or water traveling through an auxiliary gas or water meter able to communicate with the device 100 via the second interface 20, or a detailed reading of the power consumption of an equipment item which is provided by the equipment item itself or by a smartplug-type metering plug into which the equipment item is plugged).

It is also possible that information concerning consumption (of electricity, gas, water, etc.) is transmitted by the meter C in the downlink direction to permit viewing on a remote digital display 40.

In the example described here, the control data item D_PI is generated by the processing module 30 while taking into account one or more external parameters such as, for example, an event data item D_EV transmitted by the meter C via the first communication interface 10.

This may be, for example, an event data item D_EV containing information regarding an event such as a rate change, peak consumption, a deletion period, etc.

In the example described here, the control data item D_PI can also be generated by the processing module 30 while taking into consideration information from one or more equipment items such as, for example, an equipment data item D_EQ containing for example information regarding power consumption of an equipment item, this equipment data item being transmitted directly by the equipment item via the second communication interface 20.

It is therefore possible with the invention to manage the energy consumption of equipment items through intelligence embedded in the module 30.

Alternatively, the control data item D_PI may also be generated by the concentrator K or the metering information system MIS. In this case, the module 30 serves only as a relay for transmitting the control data item D_PI to the equipment items EQ1, EQ2, EQ3 concerned.

This interface 100 allows communication of any type of information; it is thus possible to envisage the module 30, based on information from a presence sensor, processing the information and controlling equipment such as an electric heater, while taking into account the rate for the period.

As mentioned above, due to the bidirectional aspect, it is also possible to provide feedback in order to detect an abnormality in the execution of a command originating from a control data item.

The architecture described above is therefore provided in particular for transmitting information from the meter C to the equipment items; said information is made secure by using for example a DLMS architecture where the meter C is the client and the device 100 is the server. Here, the meter C initiates the communication and the device 100 has no services for writes to the meter. However, it is arranged that the device can initiate communication with the meter in order to inform it of certain requests from equipment items (for example from a display device or a screen).

Those skilled in the art will understand from the description that numerous advantageous applications can be envisaged within the context of the invention, with the device 100 constituting a true home automation device for managing the equipment items of an installation and for establishing true synergy between the metering system assembly (formed by the meters, concentrators, and metering information system) and the equipment items of the installation.

The display of services related to the metering system is also possible by means of the screen 40 which provides an interface with the user and which displays associated consumption and service information, particularly recommendations and advice on energy consumption.

It is also possible to provide an alternative embodiment of the invention, wherein the information delivered by the metering to the equipment items of the “HAN” comes directly from the concentrator K, and all requests to be sent to the metering and originating from the “HAN” are made to the concentrator K. In this case, if the concentrator K does not have the data, the concentrator K in turn sends a request to the meter C to obtain the requested data, and then forwards the data to the equipment of the “HAN” for delivery to the equipment item concerned.

According to the invention, the device 100 and the meter C must first be authorized to communicate with each other, to ensure that the device 100 only has access to the data of the meter C of the installation INS and not to a nearby installation, and that the meter C only sends its data to the device 100 located in the same installation INS as the meter; the invention therefore provides a peering authentication procedure whereby the concentrator K communicates to the meter C and to the device 100 the identification and authentication data allowing them to communicate with each other.

In the context of the invention, it is also provided that all provisions have been taken to reduce the volume of the stream of information, particularly:
between the communication device and the meter and/or concentrator, and/or
between the communication modules and the equipment items of the installation.

Thus, the communication of information between the communication device and the meter mostly occurs when the data to be exchanged are relevant, for example when they change; meaning for example when the data are not continuously variable (example: a current index number that changes when the rate period changes), or when the data cross a predetermined threshold. Thus, for example, information regarding power consumption in watt-hours (Wh) is not transmitted each time it increases by 1 Wh but for example only every 10, 20, 50 Wh.

Similarly, the instantaneous power data in volt-amperes (VA) is transmitted intelligently (no transmission when there is only a slight change upwards or downwards).

This intelligent processing can be done at the meter or at the communication device, according to throughput constraints on the radio links between the communication modules and the equipment items of the installation, and/or on the PLC connection between the communication device and the meter and/or concentrator.

Furthermore, the communication device according to the invention is configured to send requests to the meter when the latter is no longer sending data, to obtain information determined over a given period of time.

It should be observed that this detailed description relates to a particular embodiment of the invention, but in no case does this description place any limitations on the object of the invention; rather, its aim is to remove any inaccuracies or misinterpretation of the following claims.

1: An architecture for bidirectional communication of data streams, comprising:
at least one equipment item of an installation, and
a metering system comprising:
a fluid meter for measuring an amount of fluid consumed by said at least one equipment item, and a concentrator,
said at least one equipment item and said fluid meter being connected to a fluid distribution network of the installation,
said architecture further comprising:
a communication device interfacing between said at least one equipment item and said metering system, and comprising:
a first communication interface configured for communicating by power-line carrier with the meter and/or said concentrator, and
a second communication interface configured for communicating wirelessly with said at least one equipment item, each of the first and second interfaces being configured for bidirectional communication of data streams between said at least one equipment item and said metering system.

2: The architecture according to claim 1, wherein said metering system further comprises a metering information system and wherein said first communication interface is configured for indirect communication with said metering information system by means of the concentrator.

3: The architecture according to claim 1, wherein the first communication interface is configured to use a narrowband power-line communications protocol such as G3-PLC.

4: The architecture according to claim 1, wherein the second communication interface comprises at least one wireless communication module arranged to communicate with said at least one equipment item according to one or more predefined wireless communication protocols.

5: The architecture according to claim 4, wherein said at least one wireless communication module comprises a removable radio dongle such as a USB dongle adapted to connect to said device electrically.

6: The architecture according to claim 1, wherein it comprises a processing module configured to transmit at least one control data item to said at least one equipment item via the second communication interface, said at least one control data item containing at least one information item for controlling fluid consumption by said at least one equipment item.

7. (canceled)

8: The architecture according to claim 6, wherein the processing module is configured to generate said at least one control data item based on at least one event data item transmitted by the meter or by the concentrator via the first communication interface and containing information relating to an event, for example such as a rate change determined by the meter, the concentrator, and/or the metering information system.

9: The architecture according to claim 6, wherein the processing module is configured to generate said at least one control data item based on at least one equipment data item containing at least one information item relating to said at least one equipment item, for example such as an amount of fluid consumed or a fluid consumption characteristic.

10: The architecture according to claim 9, wherein the equipment data item is transmitted directly by said at least one equipment item via the second communication interface.

11: The architecture according to claim 1, wherein the first communication interface is configured to transmit directly to said concentrator at least one status data item originating from said at least one equipment item and containing at least one information item relating to the status of said at least one equipment item, said at least one status data item being generated by said at least one equipment item following receipt by said at least one equipment item of said at least one control data item.

12. (canceled)

13: The architecture according to claim 1, comprising a display means configured for displaying information originating from:
the metering system, via the first interface, and/or
said at least one equipment item, via the second interface.

14: The architecture according to claim 1, wherein peering is provided in said architecture such that the concentrator communicates to the meter and to the device the identification and authentication data allowing them to communicate with each other.

15: A device for bidirectional communication of data streams between:
at least one equipment item of an installation, and
a metering system comprising: a fluid meter for measuring an amount of fluid consumed by said at least one equipment item, and a concentrator,
said at least one equipment item and said fluid meter being connected to a fluid distribution network of the installation,
wherein said communication device interfacing between said at least one equipment item and said metering system comprises:
a first communication interface configured for communicating by power-line carrier with the meter and/or with said concentrator, and
a second communication interface configured for communicating wirelessly with said at least one equipment item,
each of the first and second interfaces being configured for bidirectional communication of data streams between said at least one equipment item and said metering system.

16: The architecture according to claim 3, wherein the bidirectional communication of data streams between the meter, the concentrator, and the device is secured by a COSEM/DLMS application protocol.

17: The architecture according to claim 8, wherein the processing module is configured to generate said at least one control data item based on at least one equipment data item containing at least one information item relating to said at least one equipment item, for example such as an amount of fluid consumed or a fluid consumption characteristic.

18: The architecture according to claim 2, wherein the first communication interface is configured to use a narrowband power-line communications protocol such as G3-PLC.
